(19) United States
(12) Patent Application Publication
(10) Pub. No.: US 2021/0022949 A1
(43) Pub. Date: Jan. 28, 2021

(54) Therapeutic internal massage wand with multiple, rotational segments and variable diameter body, and method of treatment using the same

(71) Applicant: Elizabeth Janapol, Carlsbad, CA (US)

(72) Inventor: Elizabeth Janapol, Carlsbad, CA (US)

(21) Appl. No.: 16/524,121

(22) Filed: Jul. 28, 2019

(51) Int. Cl. A61H 7/00; A61H 23/02

(52) U.S. Cl. CPC A61H 7/003; A61H 23/02; A61H 2201/1692; A61H 2201/1253; A61H 2201/1685; A61H 2201/1628

(57) ABSTRACT

This invention is directed toward a pelvic therapy wand with a varying diameter. The wand also has, optionally, a segmented body that allows a pelvic therapy practitioner to transform the actual shape of the wand to treat a variety of patients with a variety of pelvic disorders and pelvic pain. The tips of the wands are also, optionally, interchangeable to give the pelvic therapy practitioner and even great range of treatment options.

### CROSS REFERENCE TO RELATED APPLICATIONS

This application claims priority to U.S. Provisional Application No. 62/700,722, filed Jul. 29, 2019, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of medical devices used to treat pelvic disorders and pelvic pain, and more specifically to the field of therapeutic wands used to treat pelvic disorders and pelvic pain.

### Brief Description of Invention

The invention is an “S-shaped” wand used to treat pelvic disorders. While the wand is roughly circular in cross-sectional view, the diameter of the wand varies in different locations on the wand. This change in diameter allows the wand to access portions of the patient's pelvic floor that are inaccessible when using the wands currently on the market. The wand also has several additional options. First, the wand can be made in several sections that are later joined together such that the actual shape of the wand can be transformed depending on the patient and the treatment intended for the patient. Second, the wand can be built with section end pieces, such that the terminal portions of the wand can be interchangeable, so as to allow a pelvic treatment professional to exchange different wand “tips” for different types of treatment.

### Brief Summary of Novel Concepts Presented by this Invention

1. A therapeutic wand with a variable diameter.

2. A therapeutic wand with segmented body capable of shape-changing

3. A therapeutic wand with interchangeable tips.

Creation of the Problem this Invention Solves

Prior to the advent of pelvic therapy wands, physical therapists specializing in pelvic therapy normally used their fingers and hands to ease tight muscles, trigger points, and discomfort. The advent of pelvic therapy wands allowed practitioners to access more easily and more deeply that was possible before. In addition, pelvic wands are much easier for self-treatment options including self-massage and myofascial release.

However, the field of pelvic therapy wands current has a number of distinctly-shaped wands, each for a different function. Since human bodies are different in terms of size and shape, and the optional treatment for each person varies, it is desirable to have a single wand that could be used for different people and different treatments.

The current invention provides just such a solution by providing a wand that has a shape designed to maximize its effectiveness when inside a patient, where the shape can be changed and various tips interchanged by the pelvic therapy practitioner to allow a practitioner with a single wand to treat a number of different patients with different pelvic disorders.

### OBJECTS OF THE INVENTION

It is therefore an object of the present invention to provide a pelvic therapy wand with a non-constant diameter to allow a medical practitioner to use the wand to treatment a pelvic disorder.

An additional object of the invention includes providing a wand made in rotatable segments such that the shape of the wand can be changed depending on the patient and the treatment desired for that particular patient's pelvic disorder.

A further object of the invention is to provide a wand with removable and interchangeable tips, to further broaden the treatment options for a patient with a pelvic disorder using a single pelvic therapy wand.

Another object of the invention is to provide an, optionally segmented and rotatable, wand with an internal vibrating electronic motor.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a side view of a therapeutic wand according to a preferred form of the invention.

FIG. 2 is side view of a segmented wand according to a preferred embodiment of the invention.

FIG. 3 is a side views of a multi-part wand.

FIG. 4 is a side view of yet another segmented wand according to a preferred embodiment of the invention.

FIG. 5 is a side view of yet another segmented wand according to a preferred embodiment of the invention.

FIG. 6 is a side view of a multi-segmented version of the invention.

FIG. 7 is a side view of a motorized version of the wand.

FIG. 8 is a side view of a multi-segmented version of the invention.

FIG. 9 is several sides views of various tips that could be attached to various body embodiments of the wand.

FIG. 10 is a side view of a multi-segmented, motorized version of the wand.

### REFERENCE NUMBERS USED

1. Therapeutic wand, generally
2. Body portion, generally
3. Front segment
4. Rear segment
5. Segment junction
6. Front tip
7. Rear tip
8. Front segment junction
9. Rear segment junction
10. Additional segment junctions
11. Additional segments
20. Motorized wand end
21. Motorized wand button
22. Motorized wand S
23. Motorized wand S-bend
24. Motorized wand tip

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

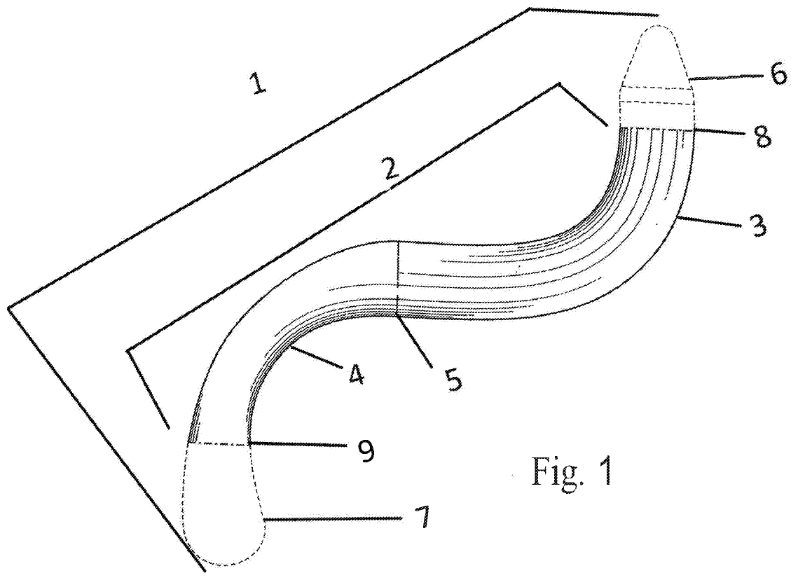

FIG. 1 is a side view of a therapeutic wand according to a preferred form of the invention. The wand, 1, is comprised of three basic units: a body portion 6, with a front tip 6 on the front and a rear tip 7 on the rear. The body portion 2 is divided into a front segment 3 and a rear segment 4 at a segment junction 5. Notice how the diameters of the various segments vary as you look up and down the wand. This different in diameter is very important to the ability of the wand to perform effective treatments. First, the narrow section gives the practitioner an effective point at which to grasp and control the wand. Second, the smaller diameter also tends to be retained at the insertion point of the patient, thereby giving the practitioner a good point of reference with respect to how far in the wand will be inserted, and thereby allows the practitioner to more accurately measure the amount of pressure that is being applied in any particular treatment. Third, the smaller diameter is more comfortable for the patient.

The segment junction 5 can be fixed, where the parts are put together during manufacture to make for a non-rotatable wand, or they can be rotationally attached, which allows for the free rotation of the front segment and the rear segment 4, allowing a practitioner to change the actual physical shape of the wand to accommodate different patients and different types of treatment. The front tip 6 and rear tip 7 are removable at a front segment junction 8 and a rear segment junction 9 respectively, giving the practitioner additional ways to modify the wand.

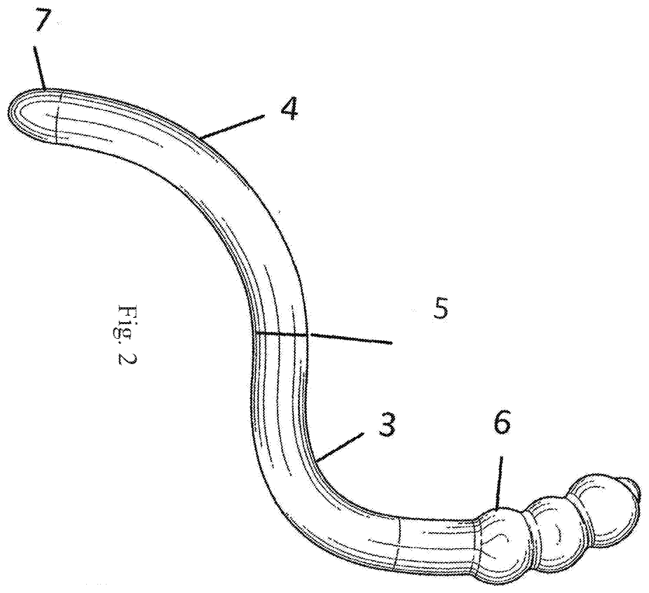

FIG. 2 is side view of a segmented wand according to a preferred embodiment of the invention. In this figure, the front tip 6 has three bulb-like structures, for a different treatment regimen as, for example, the blunted tip of the embodiment shown in FIG. 1. The front segment 3 and the rear segment 4 can be rotated in either direction through the rotatable segment junction 5.

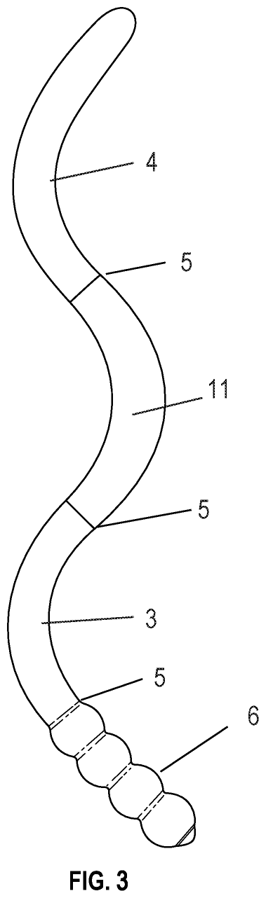

FIG. 3 is a side view of a multi-part wand, showing how the various parts of the wand can be rotated at segment junctions to perform different pelvic treatments with the same wand rotated into different configurations. For example, the front segment 3 can be rotated “up” from the additional segment 11, with the rear segment 4 can be rotated “out” to give the wand a handle. Front tip 6 can be exchanged for another front tip through removal at segment junction 5.

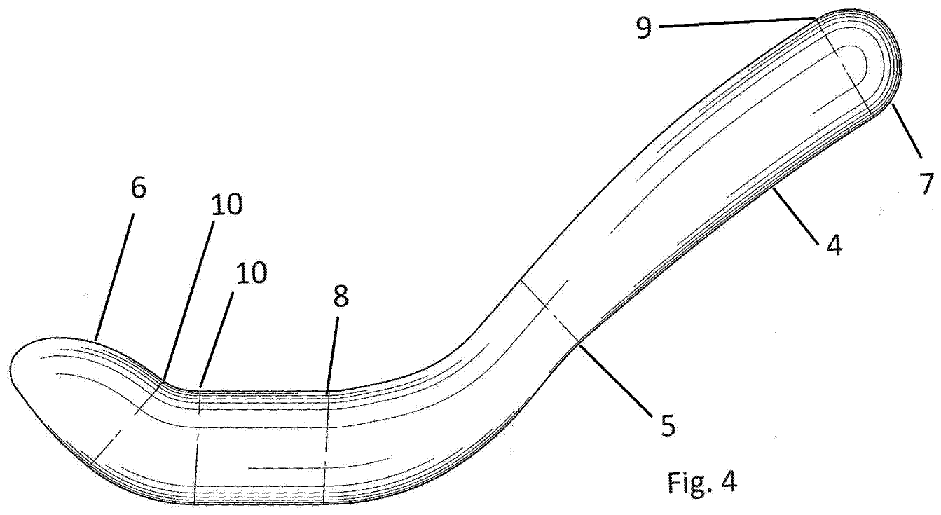

FIG. 4 is a side view of yet another segmented wand according to a preferred embodiment of the invention. In this embodiment, additional segments 11 have been added to the front segment junction 8, with additional segment junctions 10 allowing for the attachment and rotation of the additional segments 11. By adding additional segments 11 at additional segment junctions 10, the practitioner has even more ability to change the shape—thereby changing the range of treatments to be given—of the wand merely by addition sections and rotating them. Notice how the diameters of the various segments vary as you look up and down the wand. This different in diameter is very important to the ability of the wand to perform effective treatments. First, the narrow section gives the practitioner an effective point at which to grasp and control the wand. Second, the smaller diameter also tends to be retained at the insertion point of the patient, thereby giving the practitioner a good point of reference with respect to how far in the wand will be inserted, and thereby allows the practitioner to more accurately measure the amount of pressure that is being applied in any particular treatment. Third, the smaller diameter is more comfortable for the patient.

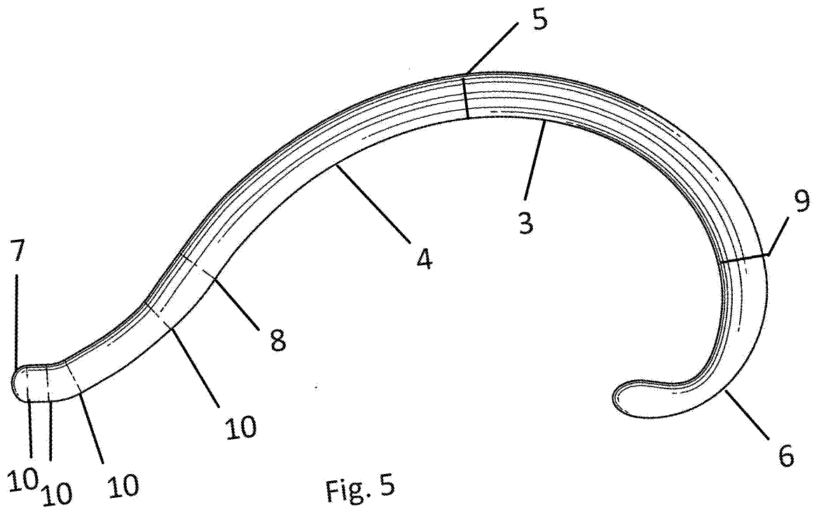

FIG. 5 is a side view of yet another segmented wand according to a preferred embodiment of the invention. In this embodiment, the front segment 3 and rear segment 4 are curved to allow for access to hard-to-reach treatment areas. The front tip 6 in this embodiment is continues the curve of the front segment 3, but could be rotated to the side if needed to provide a different treatment.

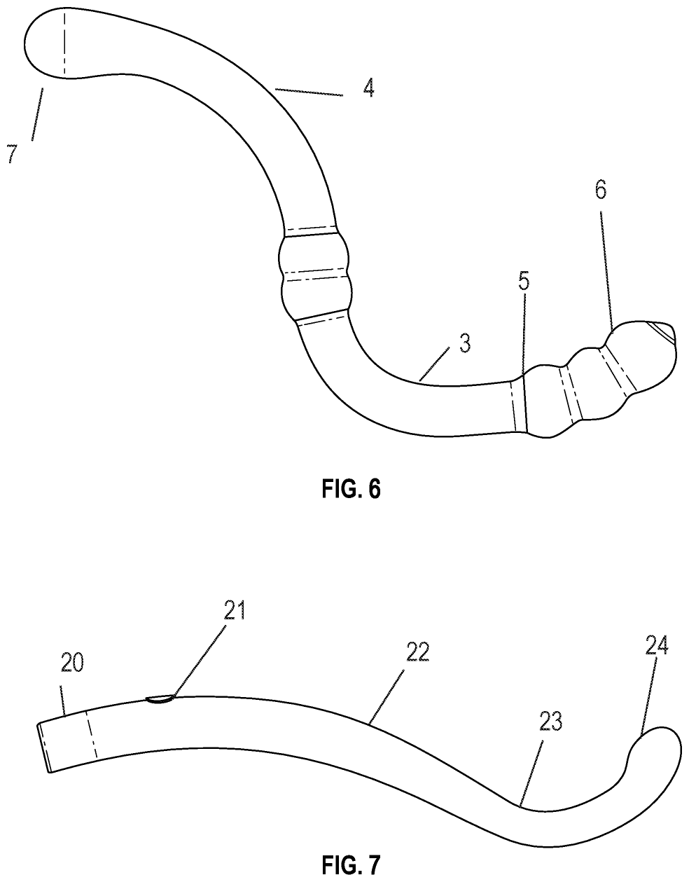

FIG. 6 is a side view of a multi-segmented version of the invention. The wand, 1, is comprised of three basic units: a body portion 6, with a front tip 6 on the front and a rear tip 7 on the rear. The body portion 2 is divided into a front segment 3 and a rear segment 4 at a segment junction 5. In this figure, the segment junctions 5 are fixed, such that the wand retains its configuration.

It is also contemplated the segment junctions 5 could allow for rotation of the various segments. In this second embodiment, the segment junction 5 allows for the free rotation of the front segment and the rear segment 4, allowing a practitioner to change the actual physical shape of the wand to accommodate different patients and different types of treatment. The front tip 6 and rear tip 7 are removable at the segment junctions 5, giving the practitioner additional ways to modify the wand.

FIG. 7 is a side view of a motorized version of the wand. And end 20 is removable to allow for replacement of the internal, rechargeable battery. The end 20 also has a USB port (not shown) to allow for charging of the internal battery. A button 21 turns the motorized wand on and off, and can have multiple vibrating functions with additional features built into the internal software. The wand has the “S” shape 22 for easy access to the particular regions of the pelvis that are difficult to reach with a standard wand, where the “S” has a curve 23 that leads to a tip 24.

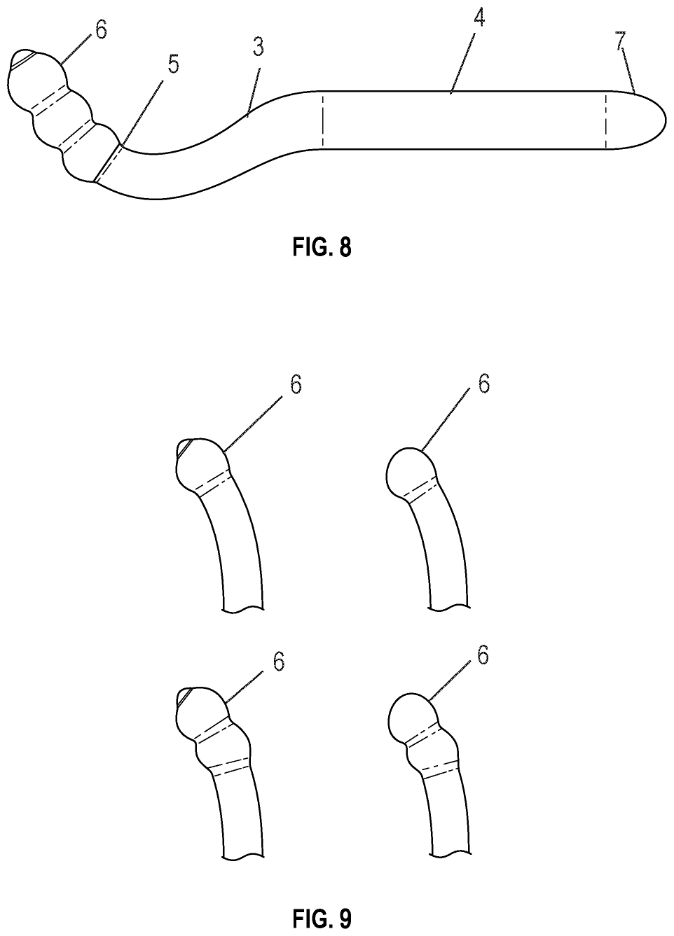

FIG. 8 is a side view of a multi-segmented version of the wand. A front tip 6 can be made removable at segment junction 5, or not removable. The wand has a rear tip 7, a rear segment 4 which serves as the handle, and a front segment 3 which is the “S” shape that allows a practitioner to reach formerly difficult-to-reach pelvic regions in a manner that is easy for the practitioner and comfortable for the patient in a clinical setting, and even allows a person suffering from pelvic therapy problems to self-heal without the help of a practitioner.

FIG. 9 is several sides views of various tips that could be attached to various end and tip portions that can be attached to various therapeutic wands described herein. These end and tip portions can be removably attached at the front segment junction (8 in FIG. 1) and the rear segment junction (9 in FIG. 1), and can also be rotated to give the practitioner additional means by which he/she can modify the wand to treat different patients, or to modify the treatment being given a single patient as the practitioner changes the treatment needed.

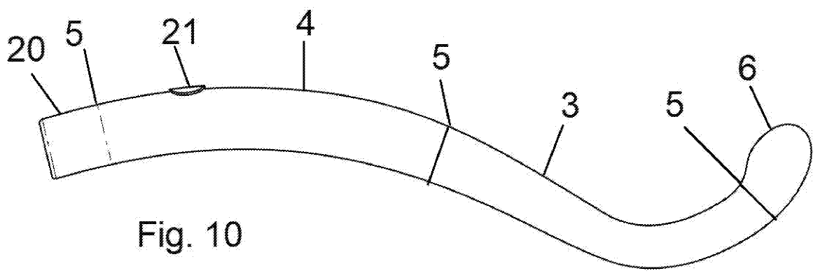

FIG. 10 is a side view of a multi-segmented, motorized version of the wand previously displayed in FIG. 7. The wand in this figure is made up of four segments, including an end part 20, a rear segment 4 which serves as a handle, a front segment 3 which displays the “S” shape that makes the wand so effective, and a front tip 6 which can be interchanged to provide the wand user with a wide variety of treatment options.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A therapeutic device for treating patients suffering from pelvic disorder and pelvic pain consisting of: a body portion, a front tip, and a rear tip, where the body portion is connected to the front tip at a front segment junction, and where the body portion is connected to the rear tip at a rear segment junction, and where the device has a plurality of diameters, including at least a first diameter and a second diameter, where at least the first diameter is different from at least the second diameter, and where the body portion is an “S” shape, where the front tip and the rear tip can be rotated 360 degrees about the body portion, where the front segment is rotably attached to the rear segment at a middle segment junction, where the front tip is rotably joined to the front segment at the front segment junction, and the rear tip is rotably joined to the rear segment at the rear segment junction, where the front tip is removable, such that the front tip can be exchanged for a second front tip, where the back tip is removable, such that the back tip can be exchanged for a second back tip, thereby allowing a user to perform more than one treatment using a single wand, were the end is a rounded end.

2. The device of claim 1, where the front tip comprises three or more contiguous rounded segments aligned in a straight line.

3. The device of claim 1, where the front tip comprises a blunted cylinder.

4. A therapeutic device for treating patients suffering from pelvic disorder and pelvic pain comprising: the body portion, the front tip, and the rear tip, where the body portion is connected to the front tip at the front segment junction, and where the body portion is connected to the rear tip at the rear segment junction, and where the device has the plurality of diameters, including at least the first diameter and the second diameter, where at least the first diameter is different from at least the second diameter, and where the body portion is the “S” shape.

5. The device of claim 4, where the body portion comprises the front segment and the rear segment, where the front segment is attached to the rear segment at the middle segment junction.

6. The device of claim 5, where the front segment junction is fixed and does not allow for rotation of the front tip, and the rear segment junction is fixed and does not allow for rotation of the rear tip.

7. The device of claim 5, where the front segment is rotably joined to the rear segment at a segment junction.

8. The device of claim 7, where the front tip and the rear tip can be rotated 360 degrees about the body portion.

9. The device of claim 8, where the front tip is removable, such that the front tip can be exchanged for a second front tip, where the back tip is removable, such that the back tip can be exchanged for a second back tip, thereby allowing a user to perform more than one treatment using a single wand, were the end is a rounded end.

10. The device of claim 4, where the body portion comprises the front segment and the rear segment, where the front segment is rotably attached to the rear segment at the middle segment junction, where the front tip is rotably joined to the front segment at the front segment junction, and the rear tip is rotably joined to the rear segment at the rear segment junction.

11. The device of claim 11, where the front segment and the rear segment can each by rotated 360 degrees.

12. The device of claim 12, where the front tip is removable, such that the front tip can be exchanged for a second front tip, where the back tip is removable, such that the back tip can be exchanged for a second back tip, thereby allowing a user to perform more than one treatment using a single wand, were the end is a rounded end.

13. The device of claim 12, where the front tip is selected from the group consisting of the blunted cylinder, a rounded end, a hook, a cone, a rounded cylinder, the three or more contiguous rounded segments aligned in a straight line, a series of three or more ball-shaped structures, and a blunted cone.

14. The device of claim 12, additionally comprising at least one additional segment, where the at least one additional segment can be connected to the device at the front segment junction and rear segment junction.

15. The device of claim 12, additionally comprising at least two additional segments, where one of the at least two additional segments is connected to the front segment junction and at least one of the at least two additional segments is connected to the rear segment junction, where each of the at least two additional segments is rotably joined to another of the at least two additional segments at one or more additional segment junctions.

16. A therapeutic device for treating patients suffering from pelvic disorder and pelvic pain comprising: the body portion, the front tip, and the rear tip, where the body portion is connected to the front tip at the front segment junction, and where the body portion is connected to the rear tip at the rear segment junction, and where the device has the plurality of diameters, including at least the first diameter and the second diameter, where at least the first diameter is different from at least the second diameter, and where the body portion is the “S” shape, where the body portion comprises the front segment and the rear segment, where the front segment is attached to the rear segment at the middle segment junction, where the front segment is rotably joined to the rear segment at a segment junction, where the front tip is removable, such that the front tip can be exchanged for a second front tip, where the back tip is removable, such that the back tip can be exchanged for a second back tip, thereby allowing a user to perform more than one treatment using a single wand, were the end is a rounded end, additionally comprising an internal motorized device capable of vibrating, where internal device capable of vibrating is inserted into a rear section cavity, and secured by attaching the rear tip, where the rear section additionally comprises an opening, and where the internal motorized device capable of vibrating additionally comprises a button, where the button projects through the opening such that a user can control the device through pressing the button.

17. The device of claim 16, where the front tip and the rear tip can be rotated 360 degrees about the body portion, where the body portion comprises the front segment and the rear segment, where the front segment is rotably attached to the rear segment at the middle segment junction, where the front tip is rotably joined to the front segment at the front segment junction, and the rear tip is rotably joined to the rear segment at the rear segment junction.

18. The device of claim 17, where the front segment and the rear segment can each by rotated 360 degrees.

19. The device of claim 18, where the rear tip is removable, and additionally comprises a seat, where the seat mates with an end of the internal motorized device capable of vibrating such that the rear tip secures the internal motorized device capable of vibrating when the rear tip is attached to the rear segment.

20. The device of claim 19, additionally comprising at least two additional segments, where one of the at least two additional segments is connected to the front segment junction and at least one of the at least two additional segments is connected to the rear segment junction, where each of the at least two additional segments is rotably joined to another of the at least two additional segments at one or more additional segment junctions.
